(19) United States
(12) Patent Application Publication
(10) Pub. No.: US 2004/0130116 A1
(43) Pub. Date: Jul. 8, 2004

(54) Vehicle service platform

(75) Inventor: Dennis Henry Glanert, Carleton, MI (US)

Correspondence Address: BROOKS KUSHMAN P.C., 1000 TOWN CENTER, TWENTY-SECOND FLOOR, SOUTHFIELD, MI, 48075, US

(73) Assignee: Livernois Vehicle Development LLC, Dearborn Heights, MI

(21) Appl. No.: 10/337,648

(22) Filed: Jan. 7, 2003

(51) Int. Cl. B60R 3/00

(52) U.S. Cl. 280/163

(57) ABSTRACT

The present invention discloses a service platform apparatus 10 for mounting to a front of a vehicle 12 for supporting a user 14 or other objects. The service platform apparatus 10 includes a generally planar platform 18 having a support surface 16. A pair of spaced apart mounting hooks 26 extend from the platform 18 for cooperating with a pair of tow hooks 24 on the vehicle 12. At least one reaction member 30 extends from the platform 18 for contacting the vehicle 12 such that the platform 18 is oriented at a generally horizontal orientation in use.

### BACKGROUND OF THE INVENTION

1. Field of the Invention

The invention relates to a platform for supporting a user or other objects thereon, more particularly to a platform for mounting to a front of a vehicle for supporting the user.

2. Background Art

The prior art recognizes a need for an elevation structure for use in combination with a vehicle such that a user may access areas or locations of a vehicle due to its elevated height. Vehicles having a size that is larger than average typically have a grill that extends well above a comfortable reach location to a user. Such vehicles may include trucks, SUVs, minivans, vans, RVs, heavy-duty trucks, or the like. These vehicles provide little access for the user to reach the various components housed underneath the hood. Additionally, such vehicles make it difficult for the user to reach certain locations atop the hood, or the windshield.

Accordingly, the prior art teaches various apparatuses and methods for reaching these hard-to-reach locations. One such example is step ladders or steps, which may be positioned on the ground or underlying surface of the vehicle such that a user has an elevated orientation with respect to the vehicle. However, such apparatuses may be unstable due to transverse loads applied by the user leaning over or toward the vehicle.

Other prior art apparatuses teach a service platform that mounts directly to the vehicle, thus providing a repeatable, elevated orientation with respect to the ground, regardless of the conditions of the ground. These prior art service platforms typically mount or attach to a front bumper or a tire of the vehicle. Although these platforms may provide an ergonomic, elevated orientation such that a user may easily reach areas over the grill, these devices are only applicable to heavy-duty vehicles that have a bumper suitable for attachment of the platform and are structurally adequate to withstand the applicable loading. With the advent of the modern vehicle marketing trend, larger vehicles, such as SUVs and smaller trucks, are being provided with a front bumper that is formed of a polymer or a chrome-plated polymer which is designed to withstand compressive forces only. These bumpers may be inadequate for supporting a service platform affixed thereto.

The prior art service platforms that may be affixed to a tire or wheel may be sufficiently supported by the tire or wheel, however these apparatuses provide a platform for a user that is oriented on an outboard lateral side of the vehicle. The advantages of these apparatuses providing an elevated orientation include tradeoffs by positioning the user at an orientation wherein only a portion or region of the hard-to-reach areas are accessible.

A further characteristic of these prior art apparatuses is that they may require many components, thus increasing material and manufacturing costs.

Therefore, a simplified and cost-effective service platform is required for providing stable and repeatable accessibility of a user to prescribed, hard-to-reach locations on or within the front of a vehicle.

### SUMMARY OF THE INVENTION

An object of the present invention is to provide a service platform apparatus for mounting to a front of a vehicle for supporting a user. The service platform apparatus comprises a generally planar platform, a pair of spaced apart mounting hooks, and a reaction member. The platform has a support surface for receiving a load thereupon. The mounting hooks extend from the platform for cooperating with a pair of tow hooks extending from the vehicle. The reaction member extends from the platform for contacting the vehicle such that the platform is both stabilized relative to the vehicle and oriented generally horizontally.

Another object of the present invention is to teach a method for mounting the service platform apparatus to the front of the vehicle for supporting the user. This method includes a first step wherein the pair of mounting hooks that extend from the platform are interconnected to the pair of tow hooks on the vehicle, at a first orientation of the platform with respect to the vehicle. Another step includes pivoting the platform and mounting hooks about a lateral axis, which is defined by a portion of the tow hooks. The platform and mounting hooks are pivoted to an orientation wherein the reaction member, which extends from the platform, contacts the structural member of the vehicle.

These and other advantages of the present invention will become apparent to one of ordinary skill in the art in light of the following description and attached drawings.

### BRIEF DESCRIPTION OF THE DRAWINGS

FIG. 1 is a quartering perspective view of an exemplary embodiment of a service platform apparatus in accordance with the present invention. The service platform apparatus is illustrated mounted to a front of a vehicle and a user is illustrated supported by the platform apparatus;

FIG. 2 is a right side elevation view of the service platform apparatus and the vehicle of FIG. 1. The service platform apparatus is also represented in phantom to illustrate another orientation of the platform relative to the vehicle;

FIG. 3 is a top plan view of another exemplary embodiment service platform apparatus in accordance with the present invention; and

FIG. 4 is a left side schematic view of the service platform apparatus of FIG. 3, and includes a free body diagram.

### DETAILED DESCRIPTION OF THE PREFERRED EMBODIMENTS

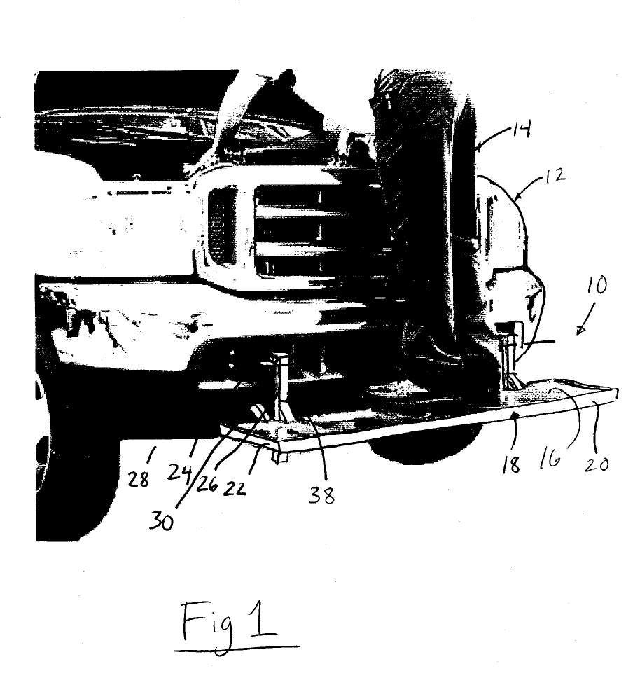

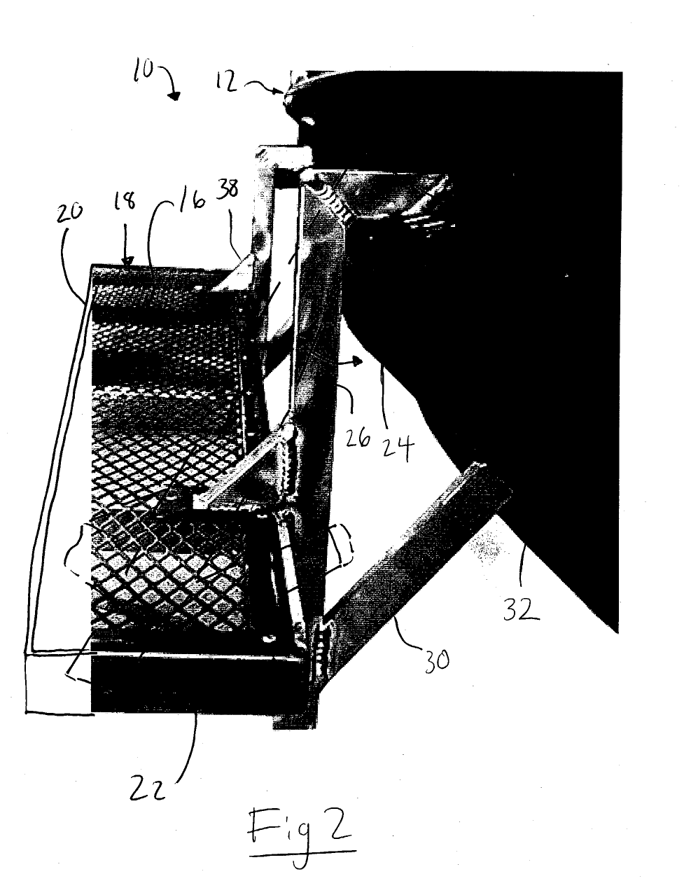

With reference to FIGS. 1 and 2, an exemplary embodiment of a service platform apparatus is illustrated in accordance with the present invention and is referenced generally by numeral 10. The service platform apparatus 10 is illustrated mounted to a front side of a vehicle 12 for supporting a user 14. The service platform apparatus 10 provides a support surface 16 for supporting the user 14 at an elevated height such that the user 14 may easily and readily access the hood, windshield, or components underneath the hood of the vehicle 12. The service platform apparatus 10 mounts directly to the vehicle 12 for stabilized support relative to the vehicle 12. Unlike prior art apparatuses that are supported on the underlying surface of the vehicle 12, the service platform apparatus 10 is repeatably mounted to the vehicle 12, regardless of the underlying surface conditions.

The service platform apparatus 10 includes a generally planar platform 18 which defines the support surface 16. The platform 18 includes a structural substrate, formed from a plurality of elongate members 20 and transverse members 22. The elongate members 20 span a length that is adequate for the user 14 to position himself stably at various locations at the front side of the vehicle 12. The transverse members 22 have a length extending away from the front of the vehicle 12 that is suitable for receiving the user's feet thereon.

Many modern vehicles are provided with tow hooks 24 that extend from the front of the vehicle 12. Examples of such vehicles include trucks, SUVs, or the like. The tow hooks 24 are generally arranged as a pair of hooks equidistantly spaced from the center of the vehicle 12. The tow hooks 24 generally include a solid or tubular member that extends from the vehicle 12 and curves, generally in an arcuate pattern having a vertical radial axis. Therefore, the tow hooks 24 collectively lie in a generally horizontal plane.

Although the tow hooks 24 are each described and illustrated as a hook having a fixed end and a terminating end, one of ordinary skill in the art can appreciate that any structural member having a similar purpose is within the scope of the present invention, regardless if the tow hooks are partially enclosed or fully enclosed, or even if the tow hooks are discrete components or a unitary component. For example, the invention contemplates that tow hooks may be defined by a pair of C-shaped members, a pair of fully enclosed eye-bolts, an elongate J-channel, or the structural equivalents thereof.

Unlike a vehicle bumper that is designed to experience compressive loads only, the tow hooks 24 are generally static in design having a solid construction that is secured directly to the frame of the vehicle 12. Specifically, the tow hooks 24 are generally designed to withstand tensile loading. However, due to the structural nature of the tow hooks 24, they are also capable of withstanding compressive and shear forces.

In order to utilize the structural advantages provided by the tow hooks 24 extending from the vehicle 12, the service platform apparatus 10 is mounted to the vehicle 12 via the tow hooks 24. The service platform apparatus 10 includes a pair of spaced apart mounting hooks 26 extending from the platform 18. The mounting hooks 26 are each sized to cooperate with one of the tow hooks 24. The mounting hooks 26 extend orthogonally from the platform 18 and have a downward facing hooked end such that the platform 18 may be suspended from the tow hooks 24. Accordingly, the tow hooks 24 support a portion of the loading applied by the service platform apparatus 10.

The mounting hooks 26 are spaced apart such that the spacing is generally equidistant with that of the tow hooks 24. More particularly, the spacing of the mounting hooks 26 is designed such that the mounting hooks 26 each engage the respective mounting hook 24 at a forwardmost portion of the tow hooks 24. In this manner, each mounting hook 26 engages a portion of the tow hook 24 that is generally coaxial with a similar portion of the other tow hook 24, collectively providing a lateral axis 28 about which the mounting hooks 26 and platform 18 may collectively pivot.

In order to stabilize the service platform apparatus 10 with respect to the vehicle 12, the service platform apparatus 10 is provided with at least one reaction member 30 for engaging a structural member of the vehicle 12. The service platform apparatus 10 is illustrated having a pair of reaction members 30 extending from the platform 18 for resting against the bumper core of the vehicle 12. The invention contemplates any number of reaction members 30 for contacting the vehicle 12 and limiting the pivotal range of movement of the service platform apparatus 10 with respect to the vehicle 12. The reaction members 30 contact the structural member of the vehicle 12 at an orientation of the service platform apparatus 10 wherein the platform 18 is oriented generally horizontally.

To prevent marring upon the surface of the vehicle 12, each reaction member 30 is provided with an elastomeric contact member 32 at the point of contact with the vehicle 12. Elastomeric contact members 32 are formed of a generally flexible material to prevent damage to the corresponding vehicle surface and to ensure an area contact rather than a point contact for proper distribution of the load applied thereto. The elastomeric contact members 32 may be formed of any flexible material such as rubber and may be secured to the reaction member 30 by any suitable method. The preferred elastomeric contact member includes a rubber element formed about a threaded rod to be fastened to the reaction member 30. These elastomeric contact members 32 are commonly referred to as rubber snubbers in the art.

Referring now to FIG. 2, a method for mounting the service platform apparatus 10 to the vehicle 12 is illustrated. First, the mounting hooks 26 of the service platform apparatus 10 are interconnected with the tow hooks 24 of the vehicle. This interconnection may be achieved at any orientation of the service platform apparatus 10 within its range of motion about the lateral axis 28, as long as the reaction members 30 are spaced away from the vehicle 12. An exemplary interconnection orientation is illustrated in phantom in FIG. 2. Next, the service platform apparatus 10 is pivoted about the lateral axis 28 to an orientation wherein the reaction members 30 contact the structural member of the vehicle 12. This pivoting may be performed by merely lowering the service platform apparatus 10 because the center of gravity of the service platform apparatus 10 is located at an outboard location with respect to the lateral axis 28. Therefore, the service platform apparatus 10 assumes the mounted orientation, as illustrated in solid in FIG. 2, due to its own weight, regardless if an external load is applied by the supported user 14 or the like.

Accordingly, the service platform apparatus 10 may be dismounted from the vehicle 12 by reversing this operation. Moreover, the service platform apparatus is pivoted to an orientation wherein the reaction members 30 are no longer in contact with the vehicle 12. Then, the mounting hooks 26 are disconnected from the tow hooks 24.

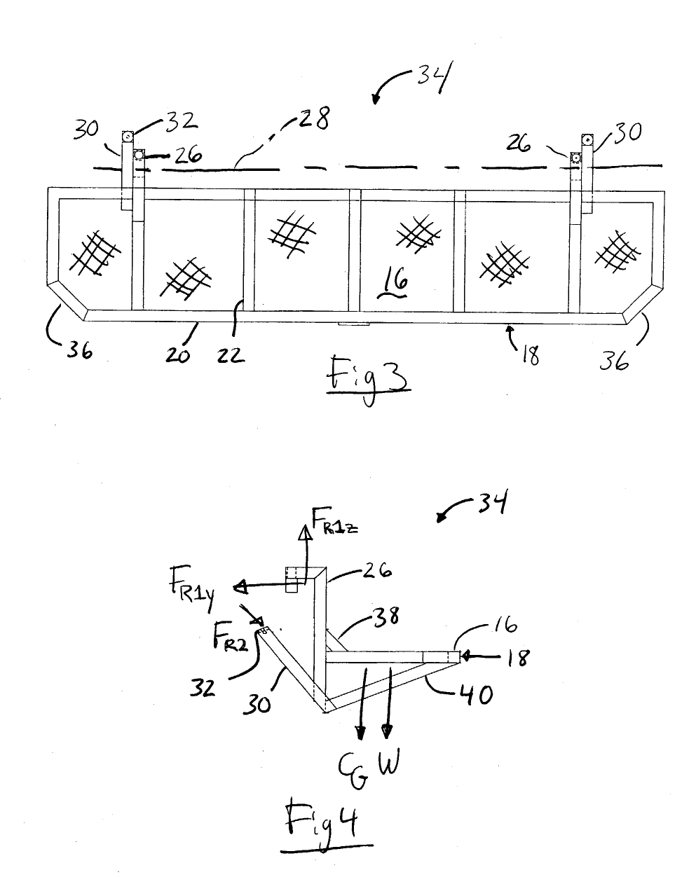

Referring now to FIG. 3, another exemplary embodiment of a service platform apparatus 34 is illustrated in accordance with the present invention. Please note that like elements retain same reference numerals and new elements are assigned new reference numerals. The present embodiment service platform apparatus 34 is similar to the prior embodiment, however, the platform 18 includes a pair of chamfered outboard corners 36 to prevent obstructions to the user 14 or others when walking about the perimeter of the service platform apparatus 34.

The invention contemplates that the service platform apparatus 34 may be constructed in any suitable manner for connecting and securing the various elements. For example, the components may be fastened together or, preferably, welded together. The preferred embodiment service platform apparatus 34 is formed of square tubing that is welded together, thus defining a weldment. The weldment is relatively light in weight and is structurally sufficient to provide a rigid and easy-to-affix or remove service platform apparatus 34. One suitable material is aluminum.

The support surface 16 is further defined as raised strand plating that is secured to the elongate and transverse members 20, 22. The plating translates the load of a user supported thereon through the elongate and transverse members 20, 22. The plating is provided with a series of raised configurations for improving traction thereon for the user. The plating also includes a series of apertures formed therein so that the support surface 16 is relatively light in weight. This plating may be formed of aluminum and may be fastened or welded to the platform 18. In order to clean the platform 18, the user 14 may merely spray the platform 18 with a hose, dip the platform 18 in a solvent tank, or perform any other suitable cleansing operation.

The invention contemplates that the service platform apparatus 34 may be formed with adjustable components, more particularly including adjustable mounting hooks 26 and adjustable reaction members 30 such that the service platform apparatus 34 may be mounted to a plurality of applicable vehicles. However, such adjustability adds material and machining costs and reduces stability through the adjustment hardware. A unitary one-piece weldment may be constructed specifically for each applicable vehicle, thus offering a low-cost and efficient service platform apparatus for each. A one-piece weldment may be constructed through manual or automated, dedicated or temporal, machining and welding operations, thus reducing the manufacturing costs when producing a number of service platform apparatuses 34.

Referring now to FIG. 4, a left side elevational schematic view of the service platform apparatus 34 is illustrated with the applicable loads indicated. This schematic is commonly referred to as a free body diagram. One load applied to the service platform apparatus 34 is the weight itself of the service platform apparatus 34, illustrated at its center of gravity (referenced by CG). Consequently, the mounting hooks 26 each experience reaction forces in both the Y and Z Cartesian coordinates, referenced respectively by F_{R1y} and F_{R1z}. The outboard displacement of the center of gravity CG relative to the lateral axis 28 causes a moment about the lateral axis (clockwise in FIG. 4). In steady state conditions, clockwise moments and applicable loading are balanced, thus resulting in a reaction force F_{R2} applied to the reaction members 36. Therefore, the mounting hooks 26 are generally subjected to a tensile load along their vertical lengths and the reaction members 30 are subjected to a compressive load. The forces applied to the tow hooks 24 cause both tensile and compressive loading, however, the tow hooks 24 are primarily in tension. Further, the reaction member 30 applies a compressive load to the structural member of the vehicle 12.

As the user 14 is supported upon the support surface 16 of the service platform apparatus 34, the weight of the user 14, and/or other objects, are applied to the service platform apparatus 34, referenced by W. This loading increases the values of the reaction forces F_{R1y}, F_{R1z} and F_{R2}.

In order to further enhance the rigidity of the platform 18, a plurality of top gussets 38 (FIG. 2) and bottom gussets 40 (FIG. 4) are affixed to the platform 18 and the respective mounting hooks 26 and reaction members 30.

In summary, the present invention provides a simplified and cost-effective service platform, which offers ergonomic advantages when mounted to a vehicle, and is structurally rigid for supporting a user without imparting excessive loads to the vehicle.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A service platform apparatus for mounting to a front of a vehicle for supporting a user or other objects, the service platform apparatus comprising:
a platform having a support surface;
a pair of spaced apart mounting hooks extending from the platform, the mounting hooks being sized to cooperate with a pair of hooks on the vehicle for supporting the platform therefrom at an elevated orientation relative to the ground, the mounting hooks having a displacement therebetween that is generally equidistant to that between the hooks; and
at least one reaction member extending from the platform for contacting the vehicle such that the platform is oriented generally horizontally in use, and the platform is stabilized relative to the vehicle for receiving and supporting a load thereon.

2. The service platform apparatus of claim 1, wherein the mounting hooks are adapted to pivot about a lateral axis that passes through the tow hooks.

3. The service platform apparatus of claim 2, wherein the platform is pivotable about the lateral axis in a range of motion, the range of motion having a limit defined by an orientation wherein the reaction member contacts the vehicle.

4. The service platform apparatus of claim 1, wherein the mounting hooks are generally subjected to a load when the platform is mounted to the vehicle.

5. The service platform apparatus of claim 1, wherein the reaction member is subjected to a compressive load when the platform is mounted to the vehicle.

6. The service platform apparatus of claim 1, wherein the at least one reaction member comprises two reaction members for enhancing the stability of the platform.

7. The service platform apparatus of claim 1, further comprising an elastomeric contact member positioned on the reaction member for providing cushioned and anti-slip contact with the vehicle.

8. The service platform apparatus of claim 1, wherein the support surface includes a series of raised configurations for improving traction thereon.

9. The service platform apparatus of claim 1, wherein the platform comprises a weldment.

10. The service platform apparatus of claim 1, wherein the platform includes at least one chamfered corner about its perimeter.

11. The service platform apparatus of claim 1, wherein the platform includes at least one gusset affixed to the platform and one of the mounting hooks.

12. The service platform apparatus of claim 1, wherein the platform includes at least one gusset affixed to the platform and the reaction member.

13. A service platform apparatus for mounting to a front of a vehicle for supporting a load, the service platform comprising:
platform means for receiving and supporting a load thereon;
support means for connecting the platform means to a pair of tow hooks on a prescribed vehicle; and
reaction means for contacting the vehicle for stabilizing the platform means.

14. A method for mounting a service platform apparatus to a front of a vehicle for supporting a load, the method comprising the steps of:
interconnecting a pair of mounting hooks that extend from a platform to a pair of tow hooks on a prescribed vehicle, at a first orientation of the platform relative to the vehicle; and
pivoting the platform and mounting hooks about a lateral axis that passes through the tow hooks, to an orientation wherein a reaction member extending from the platform contacts the vehicle.

15. A method for dismounting a service platform apparatus for supporting a load, from a front of a vehicle, the method comprising the steps of:
pivoting a platform and a pair of mounting hooks that extend from the platform, about a lateral axis that passes through a pair of tow hooks on a prescribed vehicle, to an orientation wherein a reaction member, extending from the platform, is spaced apart from the vehicle; and
disconnecting the mounting hooks from the tow hooks.
